(19) United States
(12) Patent Application Publication
(10) Pub. No.: US 2011/0001995 A1
(43) Pub. Date: Jan. 6, 2011

(54) FORM PRINTING SYSTEM, CONTROL METHOD AND COMPUTER-READABLE MEDIUM

(75) Inventor: Yuichiro Sato, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/787,392

(22) Filed: May 25, 2010

(30) Foreign Application Priority Data
Jul. 1, 2009 (JP) 2009-157315

(51) Int. Cl. G06K 15/02

(52) U.S. Cl. 358/1.11; 358/1.14; 358/1.18

(57) ABSTRACT

A form printing system comprising an information processing apparatus, a server, and a printing apparatus that are connected to each other, wherein the server includes: a device identification information management unit that manages device identification information in association with user-specific user authentication information; an encryption unit that encrypts the field data and the form information received from the information processing apparatus; an encoded code generation unit that generates the first encoded code from an encrypted character string generated by the encryption unit; an encoded code sending unit that sends the first encoded code generated by the encoded code generation unit to the information processing apparatus; a form data distribution unit that, in a case where a form data acquisition request that includes form information is received from the printing apparatus, sends form data that is in accordance with the acquisition request to the printing apparatus.

### BACKGROUND OF THE INVENTION

1. Field of the Invention

The present invention relates to a form printing system, a control method and a storage medium. More particularly, the present invention relates to a mechanism for overlay printing using a printing apparatus shared on a network.

2. Description of the Related Art

A technique called form overlay is used in order to create printed material that is created by writing data onto a prescribed form such as a ledger sheet. With form overlay, form data representing the form portion is created in advance, data such as numerical values or character strings called field data is overlaid in prescribed places of the form data, and the generated data is printed or displayed.

In another print system, print data is sent to a printer with a host computer acting as an initiator, and printing is executed by the printer. In contrast, there is a print system called a pull print system. With a pull print system, when print data is created in a client PC in order to execute printing, an IP address and a job ID of the client PC are encrypted in a USB memory and stored in the USB memory. The created print data is encrypted with the serial number of the USB memory and saved in the client PC. Information relating to the USB memory is decrypted as a result of the user inserting the USB memory into the printing apparatus and inputting a password, and print data is acquired from the client PC. The print data is then decrypted with the serial number of the USB memory, and printing is executed (see Japanese Patent Laid-Open No. 2008-90737). Also, the content (e.g., recipient's name and address) described on a form such as a delivery ticket is encrypted and encoded to obtain an encoded code, such as a QR code or similar two-dimensional code, for example, and the two-dimensional code is scanned. Description on the delivery ticket is condensed by printing the information included in the two-dimensional code on the delivery ticket (e.g., see Japanese Patent Laid-Open No. 2005-75597).

In a pull print system in which data is received from a server and printing is executed as the result of a print instruction given from a printing apparatus, print data for executing printing needs to be collected in the print server or the host computer beforehand. Also, in the case where user authentication is performed from a control panel of a printing apparatus, the device is occupied for a long time in order to input user authentication information. Further, in the case where data for printing is embedded in an encoded code, the encoded code could possibly be read by a malicious third party and information leaked.

### SUMMARY OF THE INVENTION

According to one aspect of the present invention, there is provided a form printing system comprising an information processing apparatus, a server, and a printing apparatus that are connected to each other, wherein the information processing apparatus includes: a data accepting unit that accepts user authentication information, form information and field data; an encoded code acquisition unit that sends the user authentication information, the form information and the field data to the server, and acquires a first encoded code generated by the server based on respective data that was sent; and a first output unit that outputs the acquired first encoded code, the server includes: a device identification information management unit that manages device identification information in association with user-specific user authentication information; an encryption unit that encrypts the field data and the form information received from the information processing apparatus; an encoded code generation unit that generates the first encoded code from an encrypted character string generated by the encryption unit; an encoded code sending unit that sends the first encoded code generated by the encoded code generation unit to the information processing apparatus; a form data distribution unit that, in a case where a form data acquisition request that includes form information is received from the printing apparatus, sends form data that is in accordance with the acquisition request to the printing apparatus; and a form data management unit that saves and manages form data, and the printing apparatus includes: a second encoded code reading unit that reads a second encoded code generated from information obtained by adding device identification information to an encrypted character string included in a first encoded code, and acquires the device identification information and the encrypted character string; a decryption unit that decrypts the encrypted character string acquired by the second encoded code reading unit; an encoded code analysis unit that analyses a character string decrypted by the decryption unit; a form data acquisition unit that sends form information decrypted by the decryption unit to the server, and receives form data; an overlay unit that overlays the form data together with field data decrypted by the decryption unit, and creates a form; and a control panel that provides a user interface for when configuring a print setting.

According to another aspect of the present invention, there is provided a control method of a form printing system having an information processing apparatus, a server, and a printing apparatus that are connected to each other, comprising: in the information processing apparatus, a data accepting step of a data accepting unit of the information processing apparatus accepting user authentication information, form information and field data; an encoded code acquisition step of an encoded code acquisition unit of the information processing apparatus sending the user authentication information, the form information and the field data to the server, and acquiring a first encoded code generated by the server based on respective data that was sent; and a first output step of a first output unit of the information processing apparatus outputting the acquired first encoded code, in the server, a device identification information management step of a device identification information management unit of the server managing device identification information in association with user-specific user authentication information; an encryption step of an encryption unit of the server encrypting the field data and the form information received from the information processing apparatus; an encoded code generation step of an encoded code generation unit of the server generating the first encoded code from an encrypted character string generated in the encryption step; an encoded code sending step of an encoded code sending unit of the server sending the first encoded code generated in the encoded code generation step to the information processing apparatus; a form data distribution step of a form data distribution unit of the information processing apparatus, in a case where a form data acquisition request that includes form information is received from the printing apparatus, sending form data that is in accordance with the acquisition request to the printing apparatus; and a form data management step of a form data management unit of the printing apparatus saving and managing form data, and in the printing apparatus, a second encoded code reading step of an encoded code reading unit of the printing apparatus reading a second encoded code generated from information obtained by adding device identification information to an encrypted character string included in a first encoded code, and acquiring the device identification information and the encrypted character string; a decryption step of a decryption unit of the printing apparatus decrypting the encrypted character string acquired in the second encoded code reading step; an encoded code analysis step of an encoded code analysis unit of the printing apparatus analyzing a character string decrypted in the decryption step; a form data acquisition step of a form data acquisition unit of the printing apparatus sending form information decrypted in the decryption step to the server, and receiving form data; an overlay step of an overlay unit of the printing apparatus overlaying the form data together with field data decrypted in the decryption step, and creating a form; and a control panel step of a control panel of the printing apparatus providing a user interface for when configuring a print setting.

According to the present invention, it is no longer necessary to save and manage print data for executing printing on a print server, a host computer or the like beforehand. The amount of time for which the printing device is occupied by a user can be curtailed as a result of a print instruction been given by reading an encoded code. Also, since form information and field data are encrypted with the device identification information of the mobile terminal and encoded to obtain an encoded code, the possibility of information in the encoded code being easily leaked is eliminated, even in the case where the encoded code is read by a malicious third party.

According to the present invention, management processing and necessary resources relating to saving print data can be curtailed. Occupation of the printing device by a specific user can also be curtailed. Further, security aspects can also be improved, since information unique to the apparatus used by the user is used in authentication.

Further features of the present invention will become apparent from the following description of exemplary embodiments (with reference to the attached drawings).

### BRIEF DESCRIPTION OF THE DRAWINGS

FIG. 1 shows an example system configuration according to embodiments of the present invention.

FIGS. 2A and 2B show example form output by overlaying according to embodiments of the present invention.

FIGS. 3A to 3C show example management tables according to embodiments of the present invention.

FIGS. 4A to 4C show example two-dimensional codes according to embodiments of the present invention.

FIG. 5 is a flowchart showing a first two-dimensional code generation process according to a First Embodiment.

FIG. 6 is a flowchart showing a second two-dimensional code generation process according to the First Embodiment.

FIG. 7 is a flowchart showing an overlay printing process according to the First Embodiment.

FIG. 8 is a flowchart showing an overlay printing process according to a Second Embodiment.

FIG. 9A to 9C show example interface screens in a printing apparatus according to embodiments of the present invention.

FIG. 10 is a block diagram of a server according to a Third Embodiment.

FIG. 11 is a flowchart showing a first two-dimensional code generation process according to the Third Embodiment.

FIG. 12 is a flowchart showing an overlay printing process according to the Third Embodiment.

FIG. 13 is a flowchart showing an overlay printing process according to a Fourth Embodiment.

FIG. 14 is a flowchart showing an overlay printing process according to a Fifth Embodiment.

FIG. 15 shows an example hardware configuration of a client PC and a server according to the First Embodiment.

### DESCRIPTION OF THE EMBODIMENTS

### First Embodiment

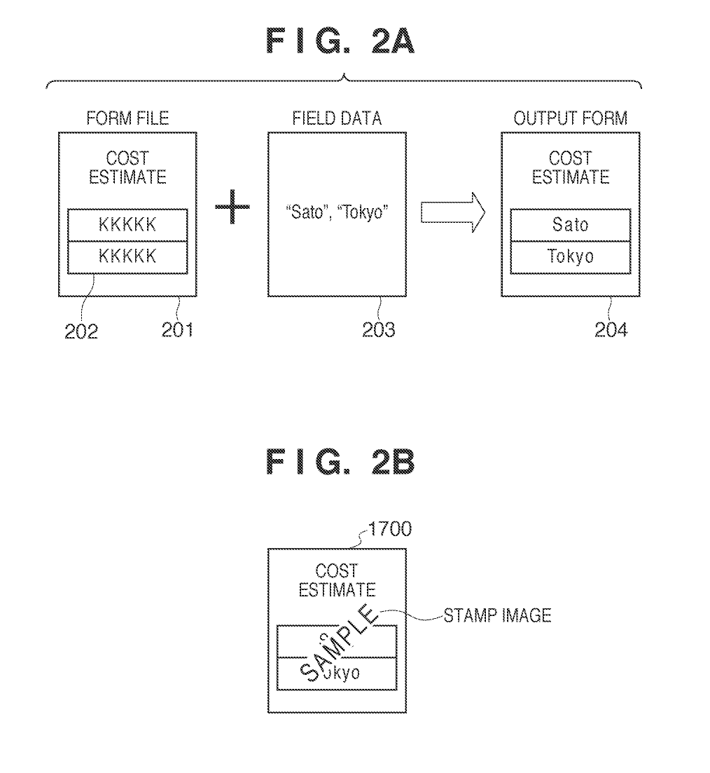

Firstly, the premise of the present invention will be described. When overlay outputting a form, the data of a data file 203 is incorporated into prescribed locations 202 (fields) of a form file 201 indicating a layout of the form to obtain an output form 204, as shown in FIG. 2A. Hereinafter, graphics 202 indicating the locations (fields) into which data is incorporated will be called field graphics, and the data file 203 will be called field data.

System Configuration

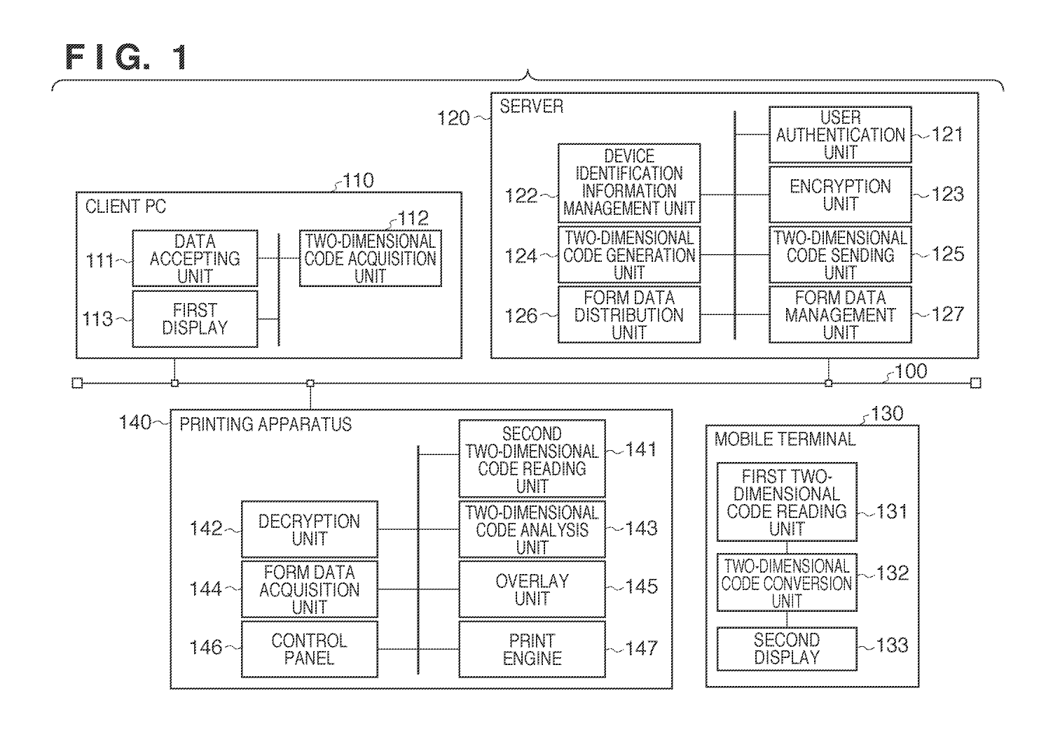

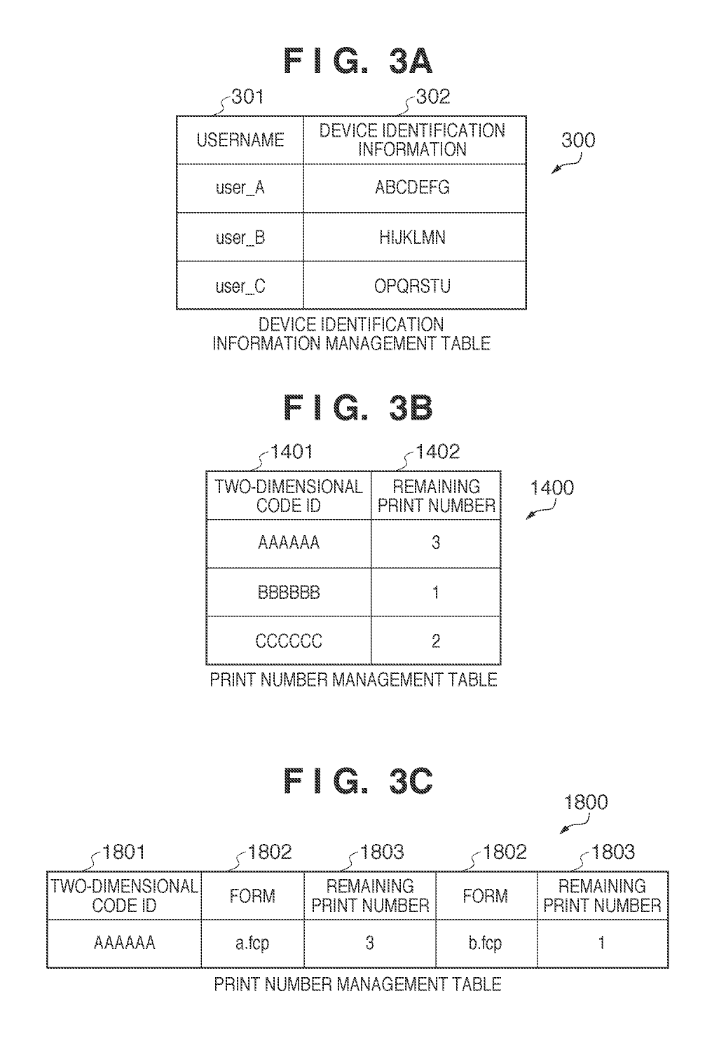

Next, embodiments for implementing the present invention will be described using the drawings. FIG. 1 is a block diagram showing an example configuration of a form printing system according to the embodiments of the present invention. As shown in FIG. 1, this form printing system is constituted by a client PC 110, which is an information processing apparatus, a server 120, a mobile terminal 130, and a printing apparatus 140 that are connected to a network 100. The mobile terminal 130 holds device identification information for identifying respective terminals. The device identification information is not particularly limited provided mobile terminals can be identified, and may be telephone numbers, serial numbers or the like. The server 120 manages user authentication information and the device identification information of mobile terminals belonging to users as a device identification information management table 300 such as shown in FIG. 3A. The device identification information management table 300 includes usernames 301 and device identification information 302 corresponding to the usernames 301. Note that in the present embodiment, the above information is held in the device identification information management table 300 as information to be managed, but the present invention is not limited thereto, and a plurality of device identification information may be held, for example. Also, the server 120 saves and manages form data for use in overlaying in a form data management unit 127. Note that the operations of the parts constituting the various apparatuses will be described in conjunction with the processing of the flowcharts discussed below.

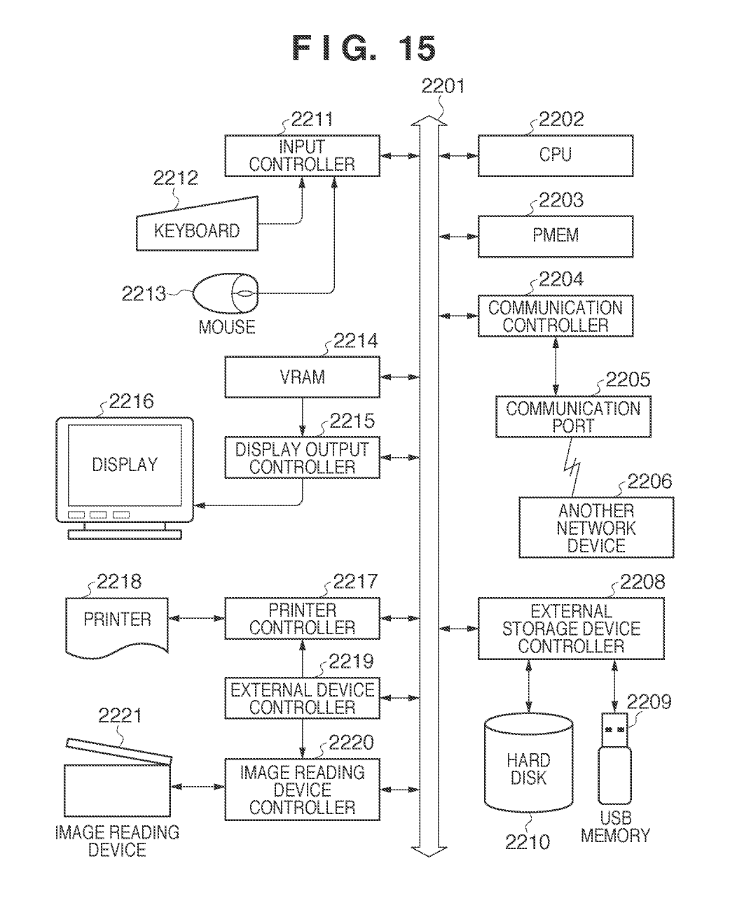

FIG. 15 shows an example hardware configuration of the client PC 110 and the server 120 according to the present embodiment. A CPU (Central Processing Unit) 2202, a program memory (PMEM) 2203, a communication controller 2204, an external storage device controller 2208, an input controller 2211, a video image memory (VRAM) 2214, a display output controller 2215, a printer controller 2217, an external device controller 2219, and an image reading device controller 2220 are connected to a system bus 2201. The communication controller 2204 controls data input/output in a communication port 2205, and a signal output from the communication port 2205 is conveyed to a communication port of another device 2206 on the network via a communication line. The external storage device controller 2208 controls access to a USB memory 2209 and a hard disk (HD) 2210, for example, as disks for data files.

Input devices such as a keyboard 2212 and a mouse 2213 are connected to the input controller 2211. An operator gives operation commands and the like in the system by operating these input devices. A display 2216 is connected to the VRAM 2214 via the display output controller 2215. The display 2216 refers to a first display 113 in FIG. 1 in the case of the client PC 110. Data to be displayed on the display 2216 is rendered to bitmap data in the VRAM 2214. The mouse 2213 is a pointing device for giving operating instructions on the display 2216.

The PMEM 2203 appropriately selects and reads programs for executing processing according to the present embodiment from the hard disk 2210, and submits the programs for execution by the CPU 2202. Data input from the keyboard 2212 is stored as code information in the PMEM 2203, which also serves as a text memory. The printer controller 2217 controls data output by a connected printer 2218. The image reading device controller 2220 is connected to an image reading device 2221, and controls this connected device. The external device controller 2219 is for controlling external devices such as a printer and a scanner. Note that with the client PC 110 and the server 120 of the present embodiment, constituent elements such as the printer 2218 and the printer controller 2217 or the image reading device controller 2220 and the image reading device 2221 that are directly connected to the client PC are not necessarily required. Note that a network such as a LAN will be described in the present embodiment. The present invention can be applied even if the communication line and the communication port 2205 connected to the communication controller 2204 constitute a common public line.

Printing Process

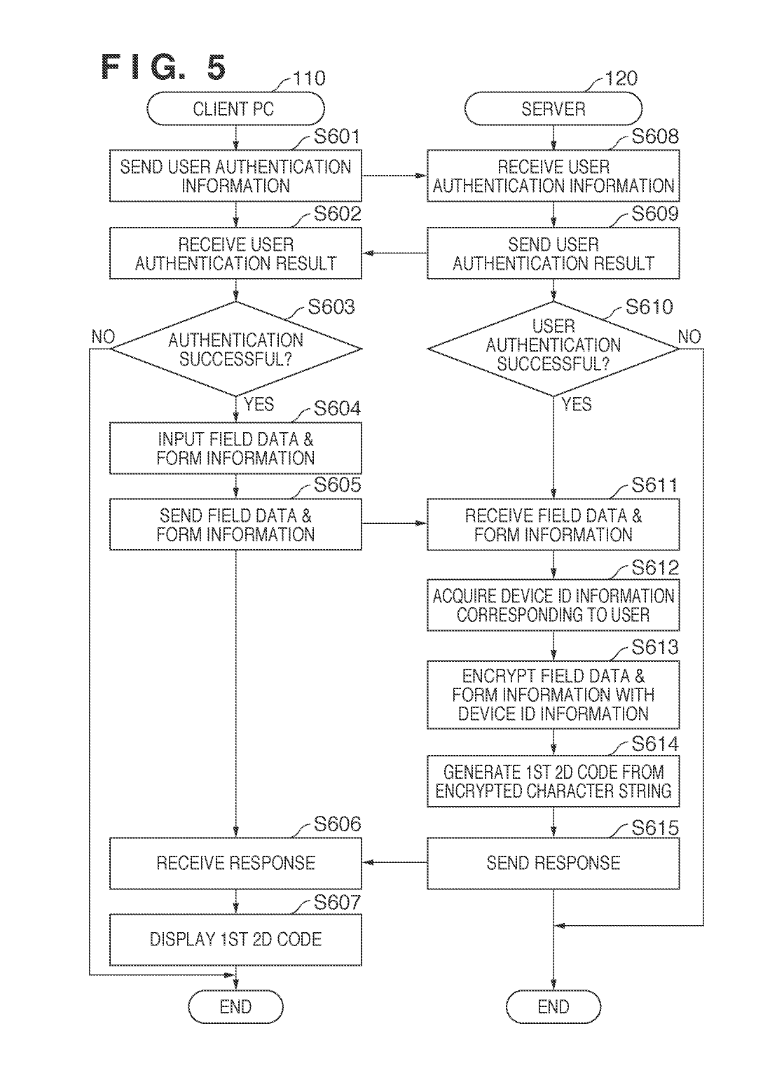

Next, the printing process of the form printing system according to the present embodiment will be described with reference to the flowcharts of FIGS. 5, 6 and 7.

First Two-Dimensional Code Generation Process

A process of generating a first two-dimensional code according to the present embodiment will be described with reference to the flowchart in FIG. 5. Here, data is assumed to be sent and received between the client PC 110 and the server 120. Firstly, in S601, a data accepting unit 111 of the client PC 110, on accepting input of user authentication information from a user, sends the user authentication information to the server 120. At this time, the user authentication method is not particularly limited, and user authentication may be performed using a password, fingerprint recognition, or the like. At S608, a user authentication unit 121 of the server 120 receives the user authentication information sent by the data accepting unit 111 of the client PC 110, and performs user authentication. At S609, the user authentication unit 121 of the server 120 sends the user authentication result to the client PC 110. At S602, the data accepting unit 111 of the client PC 110 receives the user authentication result sent by the user authentication unit 121 of the server 120. At S603 and S610, the data accepting unit 111 of the client PC 110 and the user authentication unit 121 of the server 120 respectively determine the user authentication result, and end the first two-dimensional code generation process in the case of user authentication having failed.

If, at S603, user authentication was successful, the data accepting unit 111 of the client PC 110, at S604, accepts input of field data and form information such as a form title of form data to be used in form printing. After accepting form information and field data at S604, the data accepting unit 111 sends the form information and field data to a two-dimensional code acquisition unit 112 of the client PC 110. Next, at S605, the two-dimensional code acquisition unit 112 of the client PC 110 sends the form information and field data to a two-dimensional code generation unit 124 of the server 120. At S611, an encryption unit 123 of the server 120 receives the form information and field data sent from the client PC 110.

Next, at S612, a device identification information management unit 122 of the server 120 acquires device identification information corresponding to the user authentication information received at S608 using the device identification information management table 300, and sends the device identification information to the encryption unit 123. At S613, the encryption unit 123 of the server 120 adds the respective prefixes “Form:” and “Data:” to the form information and field data. The encryption unit 123 then encrypts the form information and field data and generates an encrypted character string, using the device identification information as an encryption key. Then, the encrypted character string is sent to the two-dimensional code generation unit 124. The encryption method is not particularly limited provided it is applicable to the present invention. At S614, the two-dimensional code generation unit 124 encodes the received encrypted character string, and generates a first two-dimensional code. At S615, a two-dimensional code sending unit 125 of the server 120 sends the first two-dimensional code to the client PC 110 in response to the information received at S611. At S606, the two-dimensional code acquisition unit 112 of the client PC 110 receives the first two-dimensional code, and, at S607, the first display 113 of the client PC 110 displays the received first two-dimensional code. Note that the first display realizes a first output unit. The first two-dimensional code generation process is thereby completed.

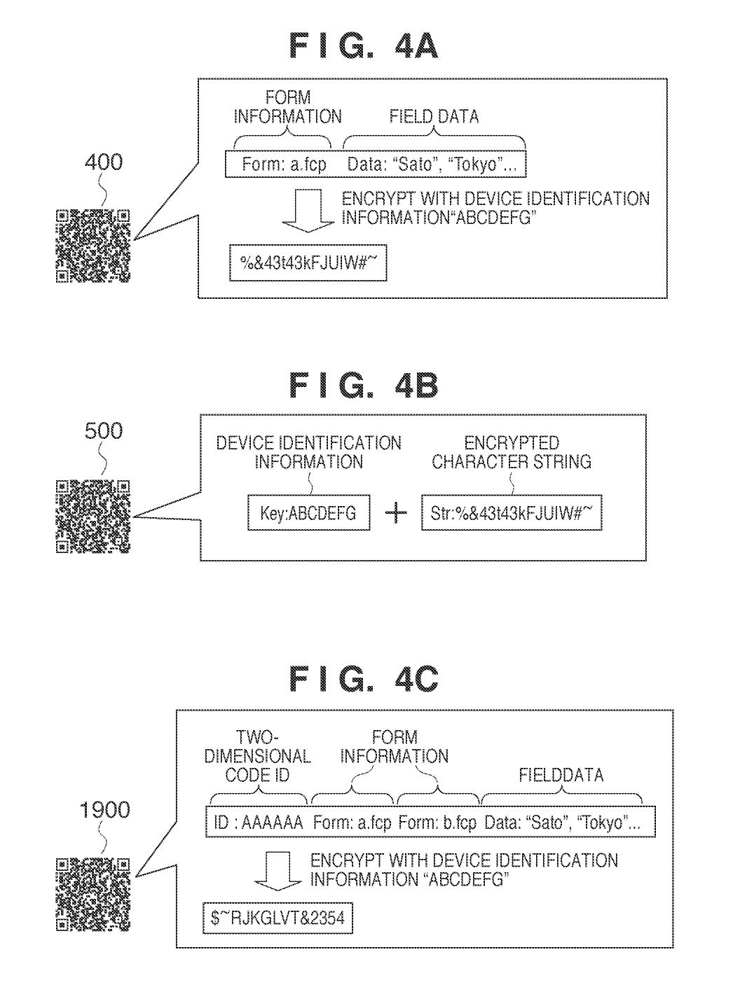

FIG. 4A is an example of a first two-dimensional code 400 in the case where the form information and the field data received by the server 120 are respectively shown as “a.fcp”, and ““Sato”, “Tokyo”, . . . ”, and where the device identification information acquired by the device identification information management unit 122 is “ABCDEFG”. In the present embodiment, a QR code (registered trademark) is used as the two-dimensional code, which is an example of encoded code, but the type of two-dimensional code is not particularly limited to a QR code (registered trademark) provided it is applicable to the present invention, and may be another type of barcode or the like. According to the present invention, the respective prefixes “Form:” and “Data:” are added in order to sort the form information and field data, but are not necessarily required, and data may be sorted using XML tags or the like. Also, in the system configuration diagram shown in FIG. 1, “two-dimensional” is assigned to the names of the parts, since a two-dimensional code is used as an example encoded code in the present embodiment, but the present invention is not restricted thereto. Specifically, the two-dimensional code acquisition unit 112, the two-dimensional code generation unit 124, the two-dimensional code sending unit 125, a second two-dimensional code reading unit 141, a two-dimensional code analysis unit 143, a first two-dimensional code reading unit 131 and a two-dimensional code conversion unit 132, may respectively be constituted as an encoded code acquisition unit, an encoded code generation unit, an encoded code sending unit, a second encoded code reading unit, an encoded code analysis unit, a first encoded code reading unit and an encoded code conversion unit.

Second Two-Dimensional Code Generation Process

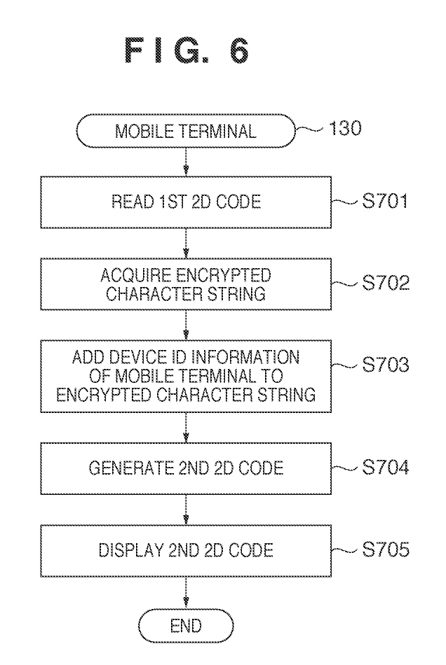

A process of generating a second two-dimensional code according to the present embodiment will be described with reference to the flowchart in FIG. 6. At S701, the first two-dimensional code reading unit 131 of the mobile terminal 130 reads the first two-dimensional code displayed on the first display 113 of the client PC 110 at S607. Here, the method of reading the first two-dimensional code is not particularly limited provided it is applicable to the present invention, and the first two-dimensional code may be read using a camera, a two-dimensional code scanner or the like attached to the mobile terminal. At S702, the two-dimensional code conversion unit 132 decodes the first two-dimensional code, and acquires the encrypted character string. At S703, the two-dimensional code conversion unit 132 acquires the device identification information of the mobile terminal, and adds the acquired device identification information to the decoded encrypted character string. For example, if the acquired encrypted character string is “% &43t43kFJUIW#˜” and the device identification information of the mobile terminal is “ABCDEFG”, the respective prefixes “Key:” and “Str:” are firstly added to the device identification information and the encrypted character string. Then, the encrypted character string is added to the device identification information, and a character string with encryption key “Key:ABCDEFG Str:% &43t43kFJUIW#˜” is generated. At S704, the two-dimensional code conversion unit 132 generates a second two-dimensional code by encoding the character string with encryption key. At S705, a second display 133 displays the second two-dimensional code. Note that the second display realizes a second output unit. The second two-dimensional code generation process is thereby completed. An example of the second two-dimensional code generated here is shown in FIG. 4B.

Overlay Printing Process

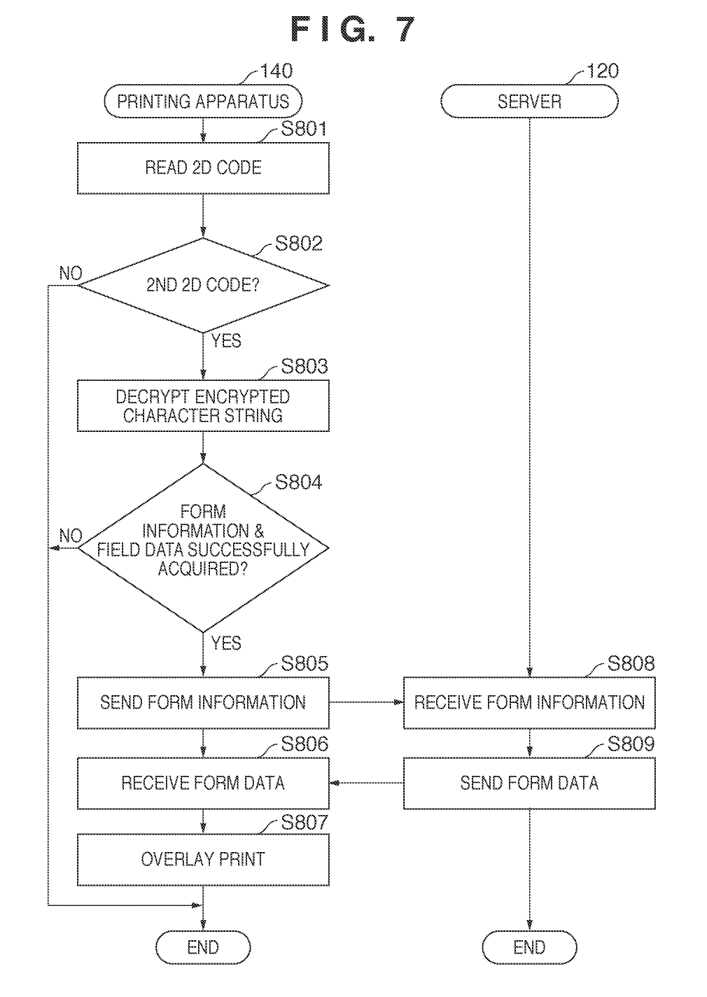

The overlay printing process according to the present embodiment will be described with reference to the flowchart in FIG. 7. At S801, the second two-dimensional code reading unit 141 of the printing apparatus 140 reads the second two-dimensional code displayed on the second display 133 of the mobile terminal 130 in S705. Here, the method of reading the second two-dimensional code is not particularly limited provided it is applicable to the present invention. At S802, the two-dimensional code analysis unit 143 of the printing apparatus 140 determines whether the read two-dimensional code is a second two-dimensional code. Specifically, the two-dimensional code analysis unit 143 searches for the device identification information prefix “Key:” and the encrypted character string prefix “Str:” included in the acquired character string, and determines whether device identification information and an encrypted character string were acquired. For example, in the case where the character string is “Key:ABCDEFG Str:%&43t43kFJUIW#˜”, a second two-dimensional code is determined to have been read, since the device identification information “ABCDEFG” and the encrypted character string “% &43t43kFJUIW#˜” were acquired. In the case where the two-dimensional code is determined not to be a second two-dimensional code, the processing is ended.

In the case where device identification information and an encrypted character string were correctly acquired, the two-dimensional code is determined to be a second two-dimensional code, and the processing proceeds to S803. At S803, a decryption unit 142 of the printing apparatus 140 decrypts the encrypted character string using the device identification information as a decryption key, and, at S804, the two-dimensional code analysis unit 143 determines whether form information and field data were correctly acquired. Specifically, the form information prefix “Form:” and the field data prefix “Data:” are searched for in the decrypted character string, and it is determined whether form information and field data were acquired. For example, in the case where the decrypted character string is “Form:a.fcp Data:“Sato”, “Tokyo”, . . . ”, the form information is “a.fcp” and the field data is “Sato”, “Tokyo”, . . . . Accordingly, form information and field data are determined to have been successfully acquired. If form information and field data could not be acquired, the device identification information added by the mobile terminal 130 is presumed to differ from the device identification information used when the encrypted character string was generated. Accordingly, if form information and field data could not be acquired from the second two-dimensional code, a person other than the user who created the first two-dimensional code is determined to have improperly acquired the first two-dimensional code and created the second two-dimensional code, and the processing is ended. In the case where form information and field data were successfully acquired, the user who created the first two-dimensional code is determined to have correctly generated the second two-dimensional code, and, at S805, a form data acquisition unit 144 of the printing apparatus 140 sends the form information to the server 120. A request to send form data is thereby made to the server 120.

At S808, a form data distribution unit 126 of the server 120 receives the form information. The printing apparatus 140 thereby makes an acquisition request for form data to the server 120. At S809, the form data distribution unit 126 of the server 120 acquires form data corresponding to the form information from the form data management unit 127, and sends the form data to the printing apparatus 140. At S806, the form data acquisition unit 144 of the printing apparatus 140 acquires the form data from the server 120, and sends the form data to an overlay unit 145. At S807, the overlay unit 145 of the printing apparatus 140 then performs an overlay process by performing form overlay on the received form data and the field data, and generates print data. Then, the print data is sent to a print engine 147, and the print engine 147 prints out the received print data. The overlay printing process is thereby completed.

According to the present embodiment, the above processing eliminates the need to save and manage print data for executing printing on a print server, a host computer or the like beforehand. Also, the amount of time that the printing device is occupied by the user can be curtailed as a result of the print instruction being given by reading a two-dimensional code. Also, since form information and field data are encrypted with the device identification information of the mobile terminal and encoded to obtain a two-dimensional code, the possibility of information in the two-dimensional code being easily leaked is removed, even in the case where the two-dimensional code is read by a malicious third party.

### Second Embodiment

In the First Embodiment, the case was described where form printing is performed after the mobile terminal 130 has added the device identification information of the mobile terminal 130 to create a second two-dimensional code. In the present embodiment, a variation of output when form printing is performed in cases such as where there is no mobile terminal 130 (e.g., where the first two-dimensional code is read with a digital camera), or where printing is performed to a paper medium and the first two-dimensional code is read from the paper medium to the printing apparatus 140 will be described. Note that since the first two-dimensional code generation process in the case of the present embodiment is similar to the First Embodiment, description thereof will be omitted.

Overlay Printing Process

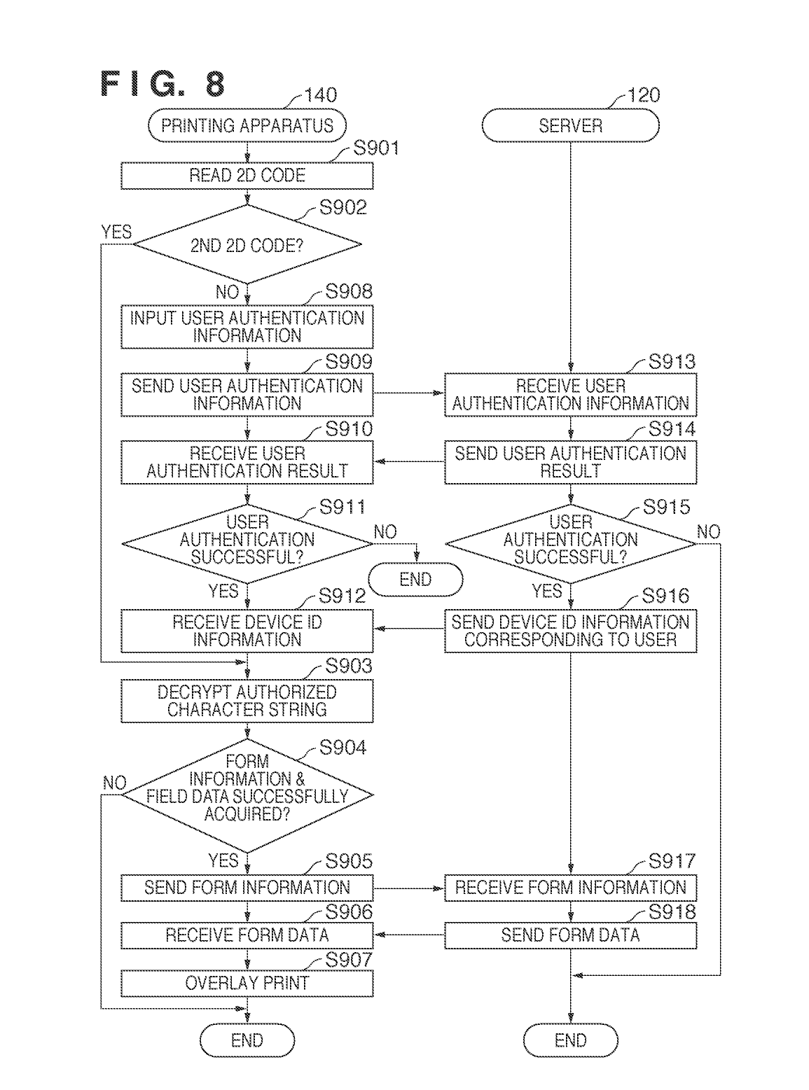

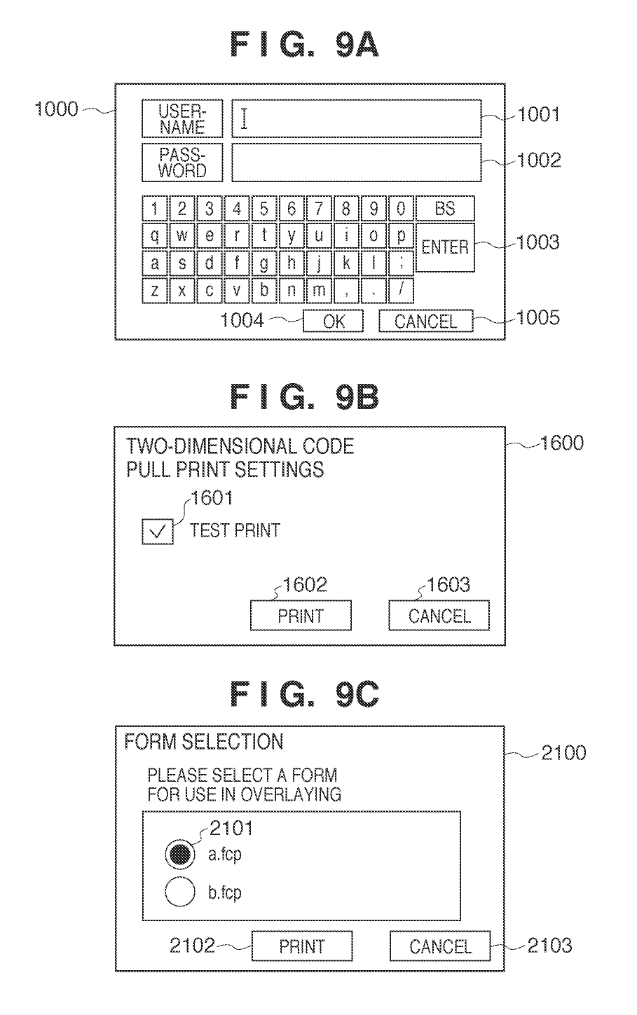

FIG. 8 is a flowchart showing the overlay printing process according to the Second Embodiment. FIG. 9A shows example screen of a user authentication input screen 1000 serving as a user interface according to the Second Embodiment. The user authentication information input screen 1000 has a username edit box 1001, a password edit box 1002, keyboard buttons 1003, a user authentication information input OK button 1004, and a user authentication information cancel button 1005. The screen serving as a user interface of the printing apparatus 140 is provided by a control panel 146. Since S901 to S907 in the case of the present embodiment are respectively similar to S801 to S807 of the flowchart in FIG. 7, description thereof will be omitted. In the case where it is determined at S902 that a second two-dimensional code was not read, the printing apparatus 140, at S908, displays the user authentication input screen 1000 on the control panel 146, and prompts the user to input user authentication information. On accepting user authentication information from the user, the printing apparatus 140, at S909, sends the user authentication information to the server 120. The printing apparatus 140 thereby makes a request for device identification information to the server 120. At S913, the user authentication unit 121 of the server 120 receives the user authentication information, and performs user authentication. At S914, the user authentication unit 121 of the server 120 sends the user authentication result to the printing apparatus 140.

At S910, the two-dimensional code analysis unit 143 of the printing apparatus 140 receives the user authentication result sent by the user authentication unit 121 of the server 120. At S911 and S915, the two-dimensional code analysis unit 143 of the printing apparatus 140 and the user authentication unit 121 of the server 120 respectively determine the user authentication result, and end the overlay printing process in the case of user authentication having failed. If, at S915, user authentication was successful, the device identification information management unit 122 of the server 120, at S916, acquires device identification information corresponding to the user authentication information received at S913 from the device identification information management table 300. The acquired device identification information is then sent to the printing apparatus 140. If a user is successfully authenticated, the device identification information of that user is thereby sent to the user in response to the request to send device identification information received at S913. At S912, the two-dimensional code analysis unit 143 of the printing apparatus 140 receives the device identification information. Since S903 to S907, S917 and S918 are respectively similar to S801 to S807, S808 and S809 of the flowchart in FIG. 7, description thereof will be omitted.

Form printing according to the present embodiment is thereby possible in cases such as where there is no mobile terminal 130, that is, where a first two-dimensional code rather than a second two-dimensional code is read to the printing apparatus 140, as a result of the printing apparatus 140 performing user authentication with the server 120 and acquiring device identification information.

### Third Embodiment

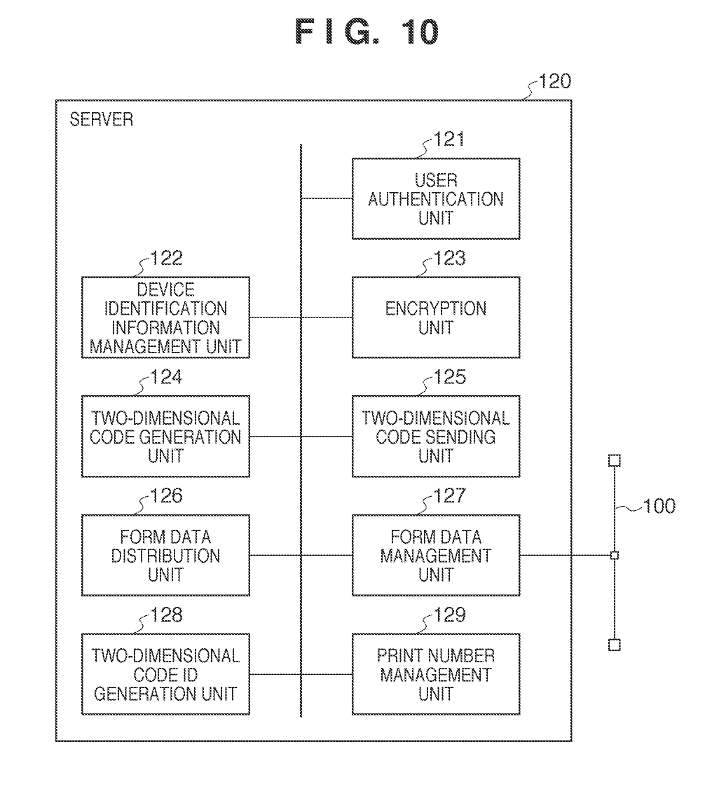

With the abovementioned First Embodiment and Second Embodiment, printing using created first and second two-dimensional codes, which are encoded codes, can be performed without restriction any number of times provided that user authentication is performed normally. However, it may be desirable to restrict the number of times a form is printed if the form is a confidential document or the like. In the present embodiment, the case where the number of times printing is performed in the form printing system is controlled will be described. FIG. 10 is an example block diagram of the server 120 according to the present embodiment. In contrast to the First and Second Embodiments, an encoded code ID that uniquely identifies the first two-dimensional code (referred to here as a “two-dimensional code ID” for convenience sake) is used. Thus, a two-dimensional code ID generation unit 128 that generates a two-dimensional code ID, and a print number management unit 129 that manages the two-dimensional code ID in association with a printable number R corresponding to the two-dimensional code ID are further provided. Note that in the present embodiment, similarly to FIG. 1, “two-dimensional” is assigned to the names of various parts since a two-dimensional code is used for the encoded code, but the present invention is not restricted thereto. Therefore, the two-dimensional code ID generation unit 128 may be constituted as an encoded code ID generation unit.

First Two-dimensional Code Generation Process

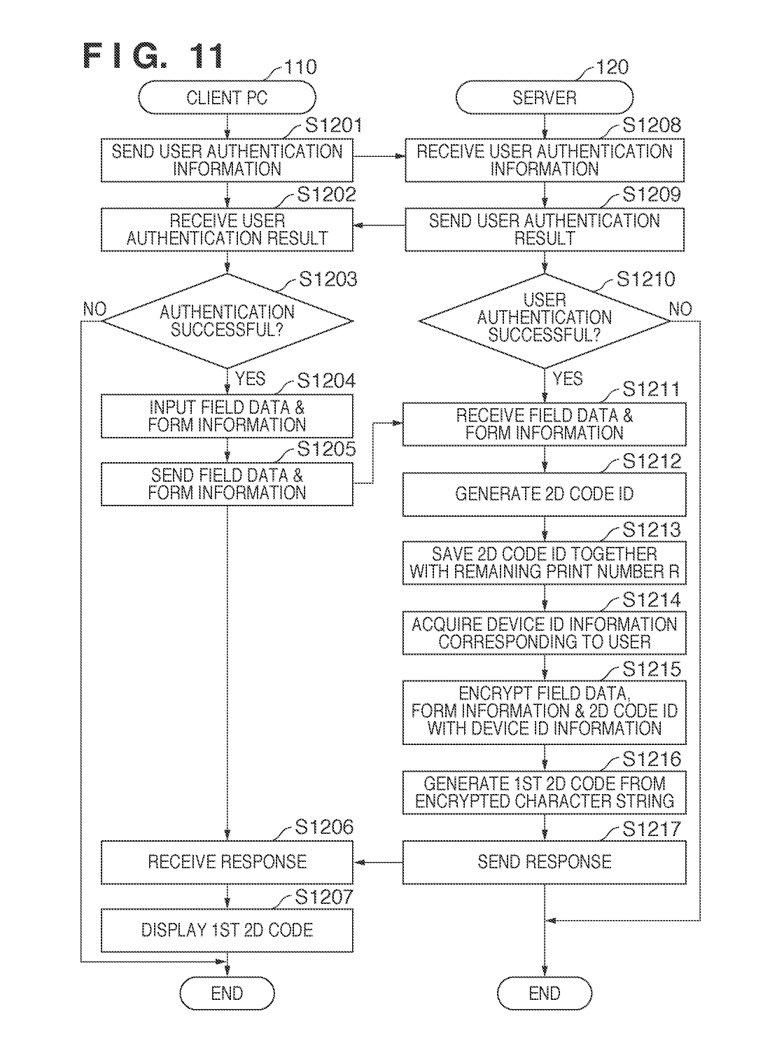

FIG. 11 is a flowchart showing a process of generating a first two-dimensional code according to the Third Embodiment. In the case of the present embodiment, S1201 to S1205 and S1208 to S1211 are respectively similar to S601 to S605 and S608 to S611 of the flowchart in FIG. 5. Accordingly, description of the above steps will be omitted here. FIG. 3B shows an example of a print number management table 1400. The print number management table 1400 holds two-dimensional code IDs 1401 and remaining print numbers 1402 corresponding to the two-dimensional code IDs 1401. In the case of the print number management table 1400 in FIG. 3B, the two-dimensional code with the two-dimensional code ID “AAAAAA” has 3 remaining prints, the two-dimensional code with the two-dimensional code ID “BBBBBB” has 1 remaining prints, and the two-dimensional code with the two-dimensional code ID “CCCCCC” has 2 remaining prints. The method of setting the initial value of the remaining print number 1402 is not particularly limited, and an initial value provided by the print number management unit 129 may be set, or a value designated and received from the two-dimensional code acquisition unit 112 of the client PC 110 may be set.

At S1212, the two-dimensional code ID generation unit 128 of the server 120 generates a two-dimensional code ID uniquely identifying the first two-dimensional code. At S1213, the print number management unit 129 saves the two-dimensional code ID and the initial value of the remaining print number 1402 in associated with each other in the print number management unit 129 as the print number management table 1400. At S1214, the device identification information management unit 122 acquires device identification information corresponding to the user authentication information received at S1208, using the device identification information management table 300, and sends the device identification information to the encryption unit 123. At S1215, the encryption unit 123 adds the respective prefixes “ID:”, “Form:” and “Data:” to the two-dimensional code ID, the form information and the field data. For example, in the case where the two-dimensional code ID is “AAAAAA”, the form information is “a.fcp” and the field data is ““Sato”, “Tokyo”, . . . ”, the generated character string will be “ID:AAAAAA Form:a.fcp Data:“Sato”, “Tokyo”, . . . ”. The encryption unit 123 generates an encrypted character string by encrypting the character string to which the prefixes have been added, using the device identification information as an encryption key, and sends the encrypted character string to the two-dimensional code generation unit 124. The method of encryption at this time is not particularly limited provided it is applicable to the present invention.

At S1216, the two-dimensional code generation unit 124 of the server 120 encodes the received encrypted character string, and generates a first two-dimensional code. At S1217, the two-dimensional code sending unit 125 sends the first two-dimensional code to the client PC 110. At S1206, the two-dimensional code acquisition unit 112 of the client PC 110 receives the first two-dimensional code sent by the server 120. At S1207, the first display 113 of the client PC 110 then displays the received first two-dimensional code. The first two-dimensional code generation process is thereby completed.

Overlay Printing Process

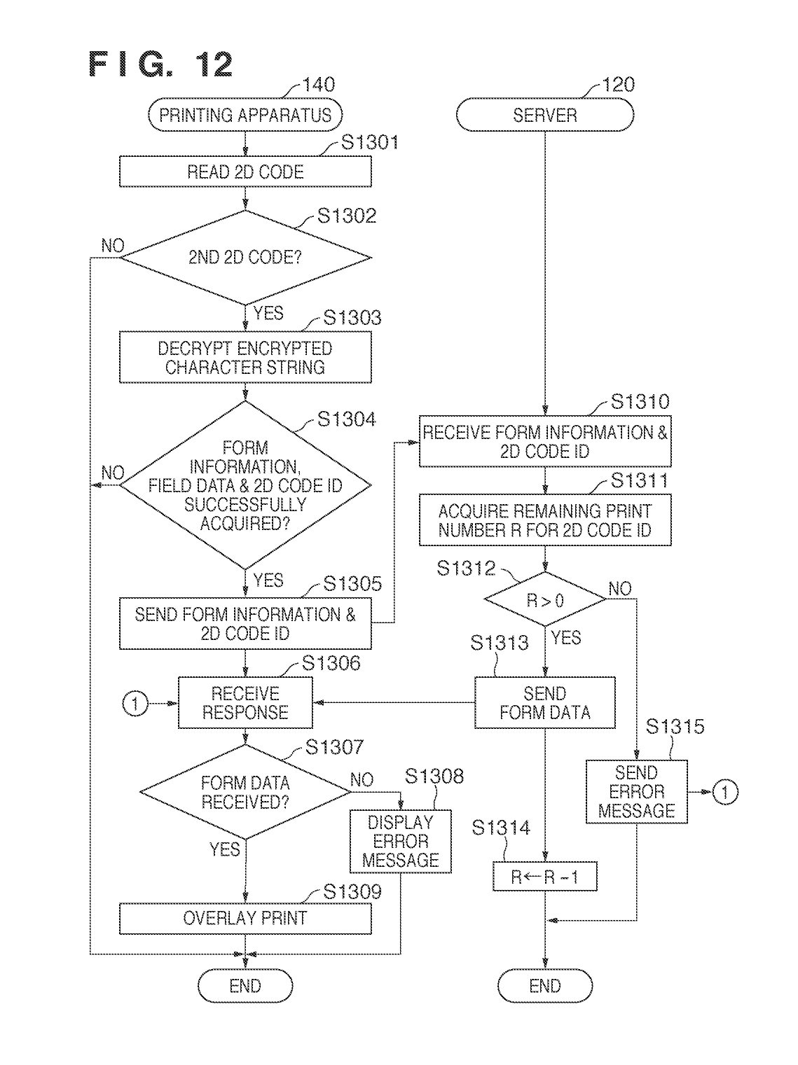

FIG. 12 is a flowchart showing the overlay printing process according to the Third Embodiment. Since S1301 to S1303 in the case of the present embodiment are respectively similar to S801 to S803 of the flowchart in FIG. 7, description thereof will be omitted. At S1304, the two-dimensional code analysis unit 143 of the printing apparatus 140 determines whether a two-dimensional code ID, form information and field data were respectively correctly acquired from the character string decrypted at S1303. Specifically, the two-dimensional code ID prefix “ID:”, the form information prefix “Form:”, and the field data prefix “Data:” are search for in the decrypted character string, and it is determined whether a two-dimensional code ID, form information and field data were acquired. Here, the case of the decrypted character string being “ID:AAAAAA Form:a.fcp Data:”Sato“, “Tokyo”, . . . ” is taken as an example. In the case of the above character string, the two-dimensional code ID will be “AAAAAA”, the form information will be “a.fcp”, and the field data will be “”Sato”, “Tokyo”, . . . ”. Accordingly, a two-dimensional code ID, form information and field data are determined to have been successfully acquired. If a two-dimensional code ID, form information and field data could not be acquired, the device identification information used when the encrypted character string was generated is presumed to differ from the device identification information added by the mobile terminal 130. Accordingly, in the case where a two-dimensional code ID, form information and field data could not be acquired, a person other than the user who created the first two-dimensional code is assumed to have improperly acquired the first two-dimensional code, and the processing is ended.

If a two-dimensional code ID, form information and field data were successfully acquired, the form data acquisition unit 144 of the printing apparatus 140, at S1305, sends the form information and two-dimensional code ID to the form data distribution unit 126 of the server 120. At S1310, the form data distribution unit 126 of the server 120 receives the two-dimensional code ID and form information sent by the printing apparatus 140. At S1311, the form data distribution unit 126 sends the two-dimensional code ID to the print number management unit 129. The print number management unit 129, having received the two-dimensional code ID, then acquires the remaining print number R from the record corresponding to the received two-dimensional code ID. For example, in the case where the two-dimensional code ID received by the print number management unit 129 is “AAAAAA” as shown in FIG. 3B, a corresponding remaining print number R of “3” will be acquired. Then, at S1312, the print number management unit 129 determines whether the remaining print number R is greater than zero (R>0). If R≦0, it is determined that printing is not possible, and an error message indicating that printing is not possible due to an insufficient remaining number of prints is sent to the form data acquisition unit 144 of the printing apparatus 140 at S1315 in response to the request, after which the overlay printing process on the server 120 side is ended. If R>0, it is determined that printing is possible, and the form data distribution unit 126 of the server 120, at S1313, sends form data corresponding to the received form information to the form data acquisition unit 144 of the printing apparatus 140 in response to the request. Then, at S1314, the print number management unit 129 of the server 120 decrements the remaining print number by setting the remaining print number R to R−1 (R=R−1). The processing on the server 120 side is then ended.

The form data acquisition unit 144 of the printing apparatus 140, at S1306, receives the response from the server 120. At S1307, the form data acquisition unit 144 determines whether form data was received. If form data was received, the overlay unit 145, at S1309, generates print data by performing form overlay on the received form data and the field data, and sends the print data to the print engine 147. The print engine 147 then outputs the received print data. If form data was not received, that is, if an error message was received, the printing apparatus 140 sends the received error message to the control panel 146, and ends the overlay printing process. The number of prints can thereby be controlled while performing form printing in the form printing system of the present invention.

### Fourth Embodiment

In the Third Embodiment, the case where the number of prints is controlled was described. However, in the case where the number of prints is restricted to one, the coloring, print settings or the like of the form output result cannot be checked. In the present embodiment, a variation that enables the form output result to be checked even in the case where the number of prints is set will be described.

Overlay Printing Process

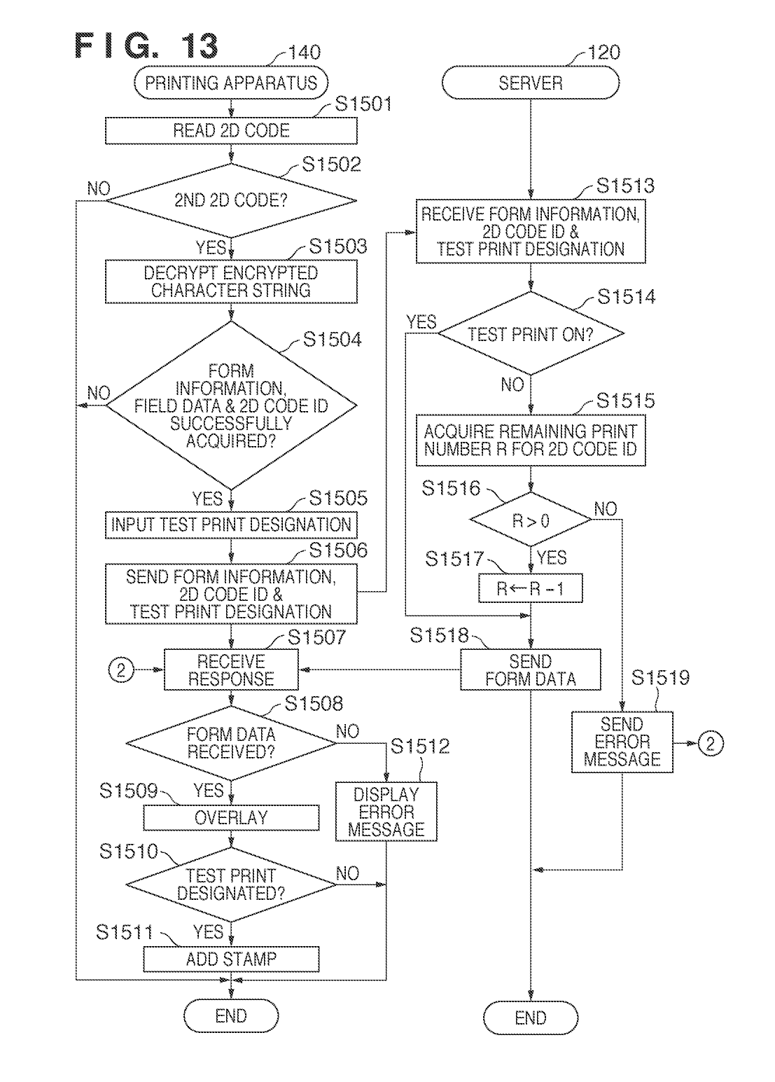

FIG. 13 is a flowchart showing the overlay printing process according to the Fourth Embodiment. Since S1501 to S1504 in the case of the present embodiment are respectively similar to S1301 to S1304 of the flowchart in FIG. 12, description thereof will be omitted. FIG. 9B is an example screen of a test print setting screen 1600 serving as a user interface according to the Fourth Embodiment. The test print setting screen 1600 has a test print designation check box 1601, a print execution button 1602, and a print cancel button 1603.

If, at S1504, a two-dimensional code ID, form information and field data were correctly acquired from the decrypted character string, the printing apparatus 140, at S1505, accepts a test print designation from the user via the test print setting screen 1600 shown in FIG. 9B. At S1506, the form data acquisition unit 144 of the printing apparatus 140 sends the test print designation accepted by the control panel 146, the form information and the two-dimensional code ID to the form data distribution unit 126 of the server 120. At S1513, the form data distribution unit 126 of the server 120 receives the two-dimensional code ID, form information and test print designation sent by the printing apparatus 140. At S1514, the form data distribution unit 126 then determines the ON/OFF state of the test print designation. If the test print designation is ON, form data corresponding to the received form information is sent to the form data acquisition unit 144 of the printing apparatus 140 at S1518, and the print number control process is cancelled. If the test print designation is OFF, the form data distribution unit 126, at S1515, sends the two-dimensional code ID to the print number management unit 129, and the print number management unit 129, having received the two-dimensional code ID, acquires the remaining print number R corresponding to the received two-dimensional code ID. Based on FIG. 3B, for example, if the two-dimensional code ID received by the print number management unit 129 is “AAAAAA”, a corresponding remaining print number R of “3” will be acquired.

At S1516, the print number management unit 129 determines whether the remaining print number R is greater than zero (R>0). If R≦0, it is determined that printing is not possible, and an error message indicating that printing is not possible due to an insufficient remaining number of prints is sent in response to the form data acquisition unit 144 of the printing apparatus 140 at S1519, after which the overlay printing process on the server 120 side is ended. If R>0, it is determined that printing is possible, and the print number management unit 129, at S1517, decrements the remaining print number by setting the remaining print number R to R−1 (R=R−1). At S1518, the form data distribution unit 126 of the server 120 sends form data corresponding to the received form information in response to the form data acquisition unit 144 of the printing apparatus 140.

The form data acquisition unit 144 of the printing apparatus 140, at S1507, receives the response sent by the server 120. At S1508, the form data acquisition unit 144 determines whether form data was received. If form data was received, the overlay unit 145, at S1509, generates print data by performing form overlay on the received form data and the field data. At S1510, the overlay unit 145 determines the ON/OFF state of the test print designation. If the test print designation is OFF, the print data is sent to the print engine 147, and the print engine 147 outputs the received print data. If the test print designation is ON, the overlay unit 145, at S1511, inserts a stamp image indicating test print in the print data, so that it can be seen at a glance from the output result that the printout is a test print. The print data is then sent to the print engine 147, and the print engine 147 outputs the received print data. If, at S1508, form data was not received, that is, if an error message was received from the server 120, the received error message is displayed on the control panel 146, and the overlay printing process is ended.

FIG. 2B is an example of a form output result 1700 when the test print designation is ON. A character string such as “SAMPLE”, for example, is inserted in the output form so that it can be seen that this is a sample print. An image held in advance in the overlay unit 145 of the printing apparatus 140 may be used for the stamp image, or alternatively a stamp image may be sent by the form data distribution unit 126 of the server 120 together with the form data, and this image may be used. The form output result can thereby be checked even in the case where the number of prints is set, by designating sample printing.

### Fifth Embodiment

In the Fourth Embodiment, an embodiment that enables the form output result to be checked by designating test printing even in the case where the number of prints is set was described. In the present embodiment, a variation in which form printing can be performed by selecting a form for use in overlaying when performing overlay printing, by designating a plurality of pieces of form information when generating the first two-dimensional code will be described.

First Two-Dimensional Code Generation Process

A process of generating a first two-dimensional code will be described using the flowchart in FIG. 11. In the present embodiment, only those portions that differ from the Third Embodiment will be described. Specifically, S1204, S1213 and S1215. Since the remaining processing is similar to the Third Embodiment, description thereof will be omitted. FIG. 3C shows an example of a print number management table 1800. The print number management table 1800 holds two-dimensional code IDs 1801, and form information 1802 and remaining print numbers 1803 corresponding to the two-dimensional code IDs 1801. The print number management table 1800 according to the present embodiment is, as shown in FIG. 3C, able to hold both a plurality of pieces of form information 1802 and a plurality of remaining print numbers 1803. That is, remaining print numbers are held in association with each two-dimensional code ID. In the case of the print number management table 1800 in FIG. 3C, the form information corresponding to the two-dimensional code with the two-dimensional code ID “AAAAAA” is “a.fcp” and “b.fcp”. The remaining print numbers corresponding to the two pieces of form information are respectively 3 for “a.fcp” and 1 for “b.fcp”. The method of setting the initial value of the remaining print numbers 1803 is not particularly limited, and an initial value provided in the print number management unit 129 of the server 120 may be set, or a value designated and received from the two-dimensional code acquisition unit 112 of the client PC 110 may be set.

At S1204, the data accepting unit 111 of the client PC 110 accepts input of field data and form information such as the form title of form data to be used in form printing, and sends the field data and form information to the two-dimensional code acquisition unit 112. At this time, the form information is not limited to one piece, and a plurality of pieces of form information can be designated. For example, two pieces of form information such as “a.fcp” and “b.fcp” can be designated as form information.

At S1213 on the server 120 side, the print number management unit 129 saves the generated two-dimensional code ID and the initial value of the remaining print numbers 1803 in association with each other in the print number management unit 129 as the print number management table 1800. At S1215, the encryption unit 123 of the server 120 adds the respective prefixes “Form:” and “Data:” to the form information and field data. If there are a plurality of pieces of form information, the prefix “Form:” is added to the respective pieces of form information. For example, in the case where the two-dimensional code ID is “AAAAAA”, the form information is “a.fcp” and “b.fcp”, and the field data is “”Sato”, “Tokyo”, . . . ”, the generated character string will be “ID:AAAAAA Form:a.fcp Form:a.fcp Data:“Sato”, “Tokyo”, . . . ”.

The encryption unit 123 of the server 120 generates an encrypted character string by encrypting the form information and field data, using the device identification information of the mobile terminal or the like used by the user as an encryption key, and sends the encrypted character string to the two-dimensional code generation unit 124. At S1216, the two-dimensional code generation unit 124 encodes the received encrypted character string, and generates a first two-dimensional code. FIG. 4C shows an example of a first two-dimensional code 1900 in the case where the form information is “a.fcp” and “b.fcp”, the field data is “”Sato”, “Tokyo”, . . . ”, the two-dimensional code ID is “AAAAAA”, and the device identification information is “ABCDEFG”.

Overlay Printing Process

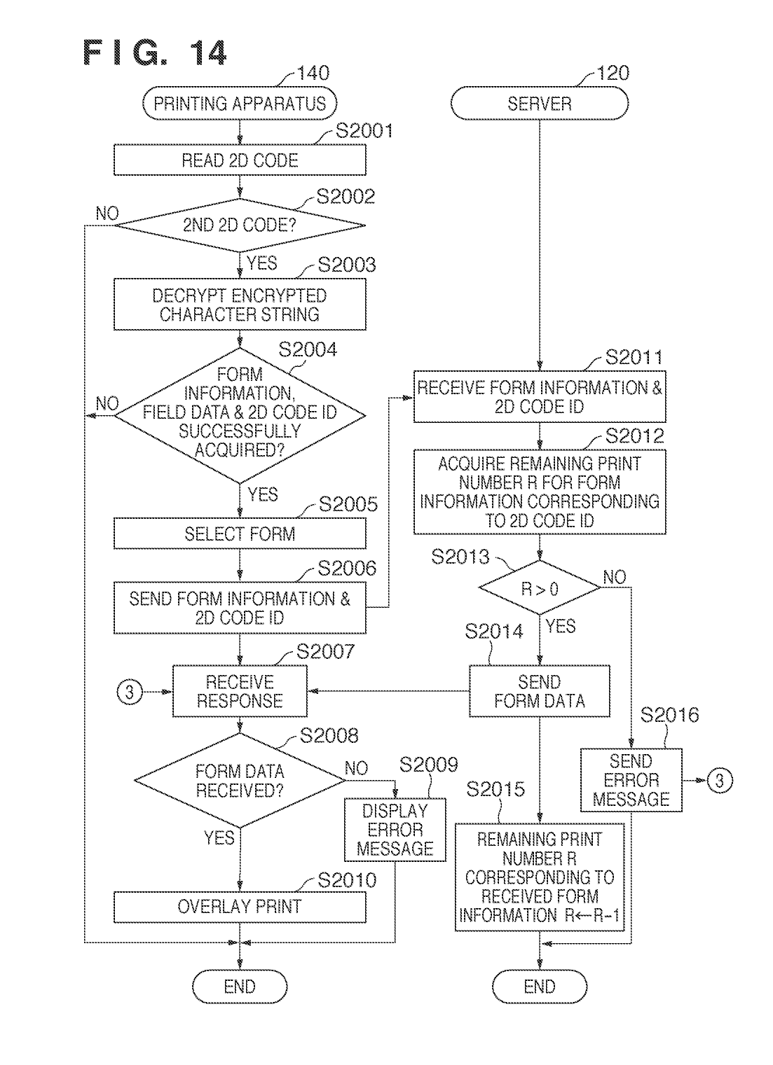

FIG. 14 is a flowchart showing the overlay printing process according to the Fifth Embodiment. Since S2001 to S2004 in the case of the present embodiment are respectively similar to S1301 to S1304 of the flowchart in FIG. 12, description thereof will be omitted. In the case where, at S2004, a two-dimensional code ID, form information and field data were successfully acquired, that is, where the user who created the first two-dimensional code is determined to have correctly generated the second two-dimensional code, designation of a form selection from the user is accepted at S2005. FIG. 9C is an example of a form selection screen 2100 serving as a user interface according to the Fifth Embodiment. The form selection screen 2100 has form designation radio buttons 2101, a print execution button 2102, and a print cancel button 2103. The user selects a form for use in the overlay process using the form selection screen 2100, and performs acquired form selection.

At S2006, the form data acquisition unit 144 of the printing apparatus 140 sends the form information and two-dimensional code ID designated by the form selection designation accepted from the user by the control panel 146 to the form data distribution unit 126 of the server 120. At S2006, the form data acquisition unit 144 of the printing apparatus 140 sends the form information and two-dimensional code ID designated by the user to the form data distribution unit 126 of the server 120. At S2011, the form data distribution unit 126 of the server 120 receives the designated form information and two-dimensional code ID. At S2012, the form data distribution unit 126 of the server 120 sends the two-dimensional code ID to the print number management unit 129. The print number management unit 129, having received the two-dimensional code ID, then acquires the remaining print number R for the received form information from the record corresponding to the received two-dimensional code ID. For example, in the case where the two-dimensional code ID received by the print number management unit 129 is “AAAAAA” and the form information is “a.fcp”, a corresponding remaining print number R of “3” is acquired according to the print number management table 1800 of FIG. 3C.

At S2013, the print number management unit 129 determines whether the remaining print number R is greater than zero (R>0). If R is less than or equal to zero (R≦0), it is determined that printing is not possible, and an error message indicating that printing is not possible due to an insufficient remaining number of prints is sent in response to the form data acquisition unit 144 of the printing apparatus 140 at S2016, after which the overlay printing process on the server 120 side is ended. If R>0, it is determined that printing is possible, and the form data distribution unit 126 of the server 120, at S2014, sends form data corresponding to the received form information to the form data acquisition unit 144 of the printing apparatus 140 in response. At S2015, the print number management unit 129 decrements the remaining print number by setting the remaining print number R corresponding to the received form information to R−1 (R=R−1).

The form data acquisition unit 144 of the printing apparatus 140, at S2007, receives the response sent by the server 120. At S2008, the form data acquisition unit 144 determines whether form data was received. If form data was received, the overlay unit 145 of the printing apparatus 140, at S2010, generates print data by performing form overlay on the received form data and the field data, and sends the print data to the print engine 147. The print engine 147 outputs the received print data. If form data was not received, that is, if an error message was received from the server 120, the received error message is sent to the control panel 146, and the overlay printing process is ended. Respective numbers of prints can thereby be controlled while performing form printing in the form printing system of the present invention, by switching a plurality of pieces of form information.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-157315, filed Jul. 1, 2009, which is hereby incorporated by reference herein in its entirety.

What is claimed is:

1. A form printing system comprising an information processing apparatus, a server, and a printing apparatus that are connected to each other,
wherein the information processing apparatus includes:
a data accepting unit that accepts user authentication information, form information and field data;
an encoded code acquisition unit that sends the user authentication information, the form information and the field data to the server, and acquires a first encoded code generated by the server based on respective data that was sent; and
a first output unit that outputs the acquired first encoded code,
the server includes:
a device identification information management unit that manages device identification information in association with user-specific user authentication information;
an encryption unit that encrypts the field data and the form information received from the information processing apparatus;
an encoded code generation unit that generates the first encoded code from an encrypted character string generated by the encryption unit;
an encoded code sending unit that sends the first encoded code generated by the encoded code generation unit to the information processing apparatus;
a form data distribution unit that, in a case where a form data acquisition request that includes form information is received from the printing apparatus, sends form data that is in accordance with the acquisition request to the printing apparatus; and
a form data management unit that saves and manages form data, and
the printing apparatus includes:
a second encoded code reading unit that reads a second encoded code generated from information obtained by adding device identification information to an encrypted character string included in a first encoded code, and acquires the device identification information and the encrypted character string;
a decryption unit that decrypts the encrypted character string acquired by the second encoded code reading unit;
an encoded code analysis unit that analyses a character string decrypted by the decryption unit;
a form data acquisition unit that sends form information decrypted by the decryption unit to the server, and receives form data;
an overlay unit that overlays the form data together with field data decrypted by the decryption unit, and creates a form; and
a control panel that provides a user interface for when configuring a print setting.

2. The form printing system according to claim 1, further comprising a mobile terminal associated with a user,
wherein the mobile terminal includes:
a first encoded code reading unit that reads the first encoded code;
an encoded code conversion unit that, in a case where the first encoded code is read, generates a second encoded code by adding device identification information of the mobile terminal to the encrypted character string included in the first encoded code; and
a second output unit that outputs the second encoded code converted by the encoded code conversion unit.

3. The form printing system according to claim 1,
wherein in the printing apparatus,
the control panel includes a user authentication information input unit that accepts user authentication information from a user,
the second encoded code reading unit includes a unit that, in a case where a first encoded code is read, sends the user authentication information accepted by the user authentication information input unit to the server, and receives device identification information corresponding to the user authentication information from the server, and
the encoded code analysis unit analyses the first encoded code, and
the server further includes a device identification information sending unit that accepts a device identification information request from the printing apparatus, and sends the device identification information corresponding to the user authentication information to the printing apparatus.

4. The form printing system according to claim 1,
wherein the server further includes:
an encoded code ID generation unit that generates an encoded code ID for uniquely identifying the first encoded code; and
a print number management unit that manages the encoded code ID in association with a remaining print number corresponding to the encoded code ID,
in the printing apparatus, the form data acquisition unit sends the form information and the encoded code ID to the server as the form data acquisition request, and
in the server,
the encryption unit encrypts the form data, the field data and the encoded code ID, and
the form data distribution unit does not send the form data in a case where the remaining print number corresponding the encoded code ID received from the printing apparatus is less than or equal to 0.

5. The form printing system according to claim 4,
wherein in the printing apparatus,
the control panel includes a test print setting unit that accepts a setting for performing a test print from a user, and
the form data acquisition unit sends the test print setting input with the control panel to the server together with the form information and the encoded code ID,
in the server, the form data distribution unit sends form data without checking the remaining print number, in a case where test printing is set in the form data acquisition request, and
in the printing apparatus, the overlay unit further adds an image for a test print to the created form in a case where test printing is set.

6. The form printing system according to claim 4,
wherein in the server,
the encoded code generation unit includes a plurality of pieces of form information in the first encoded code that is generated, and
the print number management unit holds remaining print numbers corresponding to the plurality of pieces of form information for each encoded code ID,
in the printing apparatus, the control panel includes an acquired form selection unit for selecting one of a plurality of pieces of form information acquired from the server, and
in the server, the print number management unit decrements the remaining print number corresponding to the form information received from the printing apparatus.

7. The form printing system according to claim 1,
wherein the encryption unit of the server encrypts the received field data and form information, using device identification information, managed by the device identification information management unit, that is associated with the user authentication information as a key, and
the decryption unit of the printing apparatus decrypts the encrypted character string, using the device identification information as a key.

8. A mobile terminal connected to a form printing system, comprising:
a first encoded code reading unit that reads a first encoded code;
an encoded code conversion unit that, in a case where the first encoded code is read, generates a second encoded code by adding device identification information of the mobile terminal to an encrypted character string included in the first encoded code; and
a second output unit that outputs the second encoded code converted by the encoded code conversion unit.

9. An information processing apparatus connected to a form printing system having a server, comprising:
a data accepting unit that accepts user authentication information, form information and field data;
an encoded code acquisition unit that sends the user authentication information, the form information and the field data to the server, and acquires a first encoded code generated by the server based on respective data that was sent; and
a first output unit that outputs the acquired first encoded code.

10. A server connected to a form printing system having an information processing apparatus and a printing apparatus, comprising:
a device identification information management unit that manages device identification information in association with user-specific user authentication information;
an encryption unit that encrypts field data and form information received from the information processing apparatus;
an encoded code generation unit that generates a first encoded code from an encrypted character string generated by the encryption unit;
an encoded code sending unit that sends the first encoded code generated by the encoded code generation unit to the information processing apparatus;
a form data distribution unit that, in a case where a form data acquisition request that includes form information is received from the printing apparatus, sends form data that is in accordance with the acquisition request to the printing apparatus; and
a form data management unit that saves and manages form data.

11. A printing apparatus connected to a form printing system having a server, comprising:
a second encoded code reading unit that reads a second encoded code generated from information obtained by adding device identification information to an encrypted character string included in a first encoded code, and acquires the device identification information and the encrypted character string;
a decryption unit that decrypts the encrypted character string acquired by the second encoded code reading unit;
an encoded code analysis unit that analyses a character string decrypted by the decryption unit;
a form data acquisition unit that sends form information decrypted by the decryption unit to the server, and receives form data;
an overlay unit that overlays the form data together with field data decrypted by the decryption unit, and creates a form; and
a control panel that provides a user interface for when configuring a print setting.

12. A control method of a form printing system having an information processing apparatus, a server, and a printing apparatus that are connected to each other, comprising:
in the information processing apparatus,
a data accepting step of a data accepting unit of the information processing apparatus accepting user authentication information, form information and field data;
an encoded code acquisition step of an encoded code acquisition unit of the information processing apparatus sending the user authentication information, the form information and the field data to the server, and acquiring a first encoded code generated by the server based on respective data that was sent; and
a first output step of a first output unit of the information processing apparatus outputting the acquired first encoded code,
in the server,
a device identification information management step of a device identification information management unit of the server managing device identification information in association with user-specific user authentication information;
an encryption step of an encryption unit of the server encrypting the field data and the form information received from the information processing apparatus;
an encoded code generation step of an encoded code generation unit of the server generating the first encoded code from an encrypted character string generated in the encryption step;
an encoded code sending step of an encoded code sending unit of the server sending the first encoded code generated in the encoded code generation step to the information processing apparatus;
a form data distribution step of a form data distribution unit of the information processing apparatus, in a case where a form data acquisition request that includes form information is received from the printing apparatus, sending form data that is in accordance with the acquisition request to the printing apparatus; and
a form data management step of a form data management unit of the printing apparatus saving and managing form data, and
in the printing apparatus,
a second encoded code reading step of an encoded code reading unit of the printing apparatus reading a second encoded code generated from information obtained by adding device identification information to an encrypted character string included in a first encoded code, and acquiring the device identification information and the encrypted character string;
a decryption step of a decryption unit of the printing apparatus decrypting the encrypted character string acquired in the second encoded code reading step;
an encoded code analysis step of an encoded code analysis unit of the printing apparatus analyzing a character string decrypted in the decryption step;
a form data acquisition step of a form data acquisition unit of the printing apparatus sending form information decrypted in the decryption step to the server, and receiving form data;
an overlay step of an overlay unit of the printing apparatus overlaying the form data together with field data decrypted in the decryption step, and creating a form; and
a control panel step of a control panel of the printing apparatus providing a user interface for when configuring a print setting.

13. A computer-readable medium storing a computer program for causing a mobile terminal to function as:
a first encoded code reading unit that reads a first encoded code;
an encoded code conversion unit that, in a case where the first encoded code is read, generates a second encoded code by adding device identification information of the mobile terminal to an encrypted character string included in the first encoded code; and
a second output unit that outputs the second encoded code converted by the encoded code conversion unit.

14. A computer-readable medium storing a computer program for causing an information processing apparatus to function as:
a data accepting unit that accepts user authentication information, form information and field data;
an encoded code acquisition unit that sends the user authentication information, the form information and the field data to a server, and acquires a first encoded code generated by the server based on respective data that was sent; and
a first output unit that outputs the acquired first encoded code.

15. A computer-readable medium storing a computer program for causing a server to function as:
a device identification information management unit that manages device identification information in association with user-specific user authentication information;
an encryption unit that encrypts received field data and form information;
an encoded code generation unit that generates a first encoded code from an encrypted character string generated by the encryption unit;
an encoded code sending unit that sends the first encoded code generated by the encoded code generation unit to an information processing apparatus;
a form data distribution unit that, in a case where a form data acquisition request that includes form information is received from a printing apparatus, sends form data that is in accordance with the acquisition request to the printing apparatus; and
a form data management unit that saves and manages form data.

16. A computer-readable medium storing a computer program for causing a printing apparatus to function as:
a second encoded code reading unit that reads a second encoded code generated from information obtained by adding device identification information to an encrypted character string included in a first encoded code, and acquires the device identification information and the encrypted character string;
a decryption unit that decrypts the encrypted character string acquired by the second encoded code reading unit;
an encoded code analysis unit that analyses a character string decrypted by the decryption unit;
a form data acquisition unit that sends form information decrypted by the decryption unit to the server, and receives form data;
an overlay unit that overlays the form data together with field data decrypted by the decryption unit, and creates a form; and
a control panel that provides a user interface for when configuring a print setting.
